(19) United States
(12) Patent Application Publication
(10) Pub. No.: US 2001/0054642 A1
(43) Pub. Date: Dec. 27, 2001

(54) Method and apparatus for the processing of a web material

(76) Inventors: Markus Landolt, Zurich (CH); Kurt Zerzawy, Villnachern (CH)

Correspondence Address: Patrick C. Keane, BURNS, DOANE, SWECKER & MATHIS, L.L.P., P.O. Box 1404, Alexandria, VA, 22313-1404, US

(21) Appl. No.: 09/879,178

(22) Filed: Jun. 13, 2001

(30) Foreign Application Priority Data
Jun. 15, 2000 (EP) 00 111 936.1
Mar. 2, 2001 (EP) 01 104 513.5

(51) Int. Cl. G06F 17/00

(52) U.S. Cl. 235/375

(57) ABSTRACT

The beginning of a web material fed to a processing device and stored in the form of a roll on a core is provided with a machine readable code which represents an identification code for the web material as well as property data relevant for the processing of the web material. The identification code and the property data are read in at the beginning of the processing of the web material and only web materials with valid identification code are admitted for processing. The processing device is adjusted to the web material used by way of the read in property data. At termination of the processing, the identification code and the updated property data of the web material are again recorded in machine readable code onto the beginning of the remaining web material so that they are again available for the next processing procedure. Alternatively, the identification code and the property data can also be stored in a storage element activatable by electromagnetic waves which is mechanically connected with the web material. In this manner, the use of unintended web material types can be stopped. The manual entry of property data can be obviated and a higher user-friendliness achieved. Furthermore, incorrect manipulations are substantially prevented.

### FIELD OF THE INVENTION

The invention relates to a method for the processing of a web of material stored in the form of a roll and to an apparatus for the processing of a web of material stored in the form of a roll.

### BACKGROUND OF THE INVENTION

So called mini-labs equipped with printers (especially inkjet printers) are more and more being used for the manufacture of paper prints from originals of the classic type or digital type. The paper to be printed is usually stored in the form of a roll in a cassette, whereby during practical operation cassettes with different paper types (qualities), paper widths and paper lengths are interchangeably used. Paper type, paper width and paper length are in the following referred to as property data and are relevant for the processing of the paper to be printed.

It is necessary for a correct and failure-free progress of the print manufacture or the function of the mini-lab that the mini-lab or its control has knowledge of the property data of the paper respectively used. So far, those data have been fed to the mini-lab by manual entry. However, according to experience this relatively often leads to false entries which then generally lead to a bad picture quality. Furthermore, it is not possible, to date, to exactly state the length of the paper remaining in an already partially used paper cassette.

It is known to use correspondingly coded paper cassettes for the automatic recognition of the paper width. However, the paper type is not apparent therefrom and especially not the length of the still remaining paper. It is a further prerequisite for the correct and failure-free progress of the print production or the function of the mini-lab that the paper used is generally a web of material which complies with the quality requirements set by the manufacturer of the mini-lab. Since high-quality paper is relatively expensive, the temptation is high to replace it with paper that is cheaper but also of lower quality. When the prints produced on such lower quality paper are then of unsatisfactory quality, the mini-lab is often blamed which is of course not in the interest of the manufacturer of the mini-lab.

### SUMMARY OF THE INVENTION

It is now an object of the present invention to overcome this problem and to improve a generic method and apparatus in such a way that the use of not intended web material qualities is reliably prevented or at least rendered economically uninteresting for the operator of the processing arrangement.

This object is achieved through a method for processing a web of material stored in the form of a roll wound on a core, wherein an identification code is applied to the material or the core.

According to the basic goal of the invention, the web of material is marked by a clearly machine readable identification code which code is read and checked prior to processing, whereby the web of material is not accepted for processing unless a valid identification code has be recognized. The use of web materials which are not approved is prevented in this manner.

It is another object of the invention to further improve the method and apparatus so that no manual entries of the process relevant properties of the web of material to be processed are required and that a higher user-friendliness is achieved and incorrect manipulations prevented as much as possible.

This is achieved in accordance with another important feature of the invention in that the relevant property data of the web of material are recorded in machine readable format on the latter, read out prior to processing and then used for the adjustment of the processing arrangement. After completion of the processing, the updated property data are again recorded on the remaining portion of the web of material so that they are again available upon a further processing of the web of material. Alternatively, the data are connected with the wind-up core on which the web of material is rolled-up, whereby preferably a passive storage element is used as a data carrier, which is activated and accessed by way of electromagnetic waves.

It is especially practical according to a further important aspect of the invention to use for the admissibility testing of a web of material not only the identification code but the combination thereof with the remaining length of the web of material left in the roll. Manipulation attempts can be prevented in this way with a level of security sufficient for practical applications.

### BRIEF DESCRIPTION OF THE DRAWINGS

The invention is further described in the following by way of the drawings, wherein

FIG. 1 is a schematic overview of a first preferred embodiment of the processing arrangement in accordance with the invention;

FIG. 2 is a starting piece of a web of material provided with a machine readable code in accordance with the invention;

FIG. 3 is a schematic overview of a second preferred embodiment of the processing device in accordance with the invention; and

FIG. 4 is a process schematic of the process in accordance with the invention.

### DETAILED DESCRIPTION OF THE PREFERRED EMBODIMENTS

The processing device in accordance with the invention includes an actual processing unit 1, a control unit 2 for the control and operation thereof, a reader arrangement 3 which is constructed as a barcode reader, a recording arrangement 4 which is constructed as a barcode printer and an administration arrangement 5. Furthermore, a cassette 6 is provided which includes a roll 7 of a web of material P to be processed and wound onto a core 8, which web is fed for processing to the processing unit 1 by way of transport means (not illustrated). With the exception of the presence of the reader arrangement 3, the recording arrangement 4 and the administration arrangement 5, the processing device completely and fully corresponds to the prior art so that further explanation of the remaining components is not necessary.

In the case of a mini-lab or a comparable processing device, the processing unit 1 includes the conventional picture producing components of a mini-lab, especially the printer and the associated peripherals used for the image recording. The control unit 2 then corresponds to the functional units normally present in a mini-lab for the control and operation of the mini-lab and the web of material P is the paper to be printed. Especially in that case, further explanation is also unnecessary.

What is new compared to conventional processing devices in general and mini-labs in particular is the presence of the reader arrangement 3, the recording arrangement 4 and the administration arrangement 5.

In the following, the invention will only be further described for the application in a mini-lab, however, it is understood that the description applies in the same or analog manner also to any other type of processing of a web of material.

As already mentioned in the beginning, it is a pre-requisite for the correct and failure-free progress of the picture manufacture or the function of the mini-lab that the paper or in general web material used complies with the quality requirements set by the manufacturer of the mini-lab or, in other words, that the intended “correct” paper or web material is used. In order to guarantee this with sufficient certainty for the practical application, the paper is marked in accordance with the basic idea of the invention with a clear, preferably unique, machine-readable identification code, for example, a serial number. The identification code is automatically read and checked for correctness before the processing of the paper in the processing device. If no correct identification code is detected, the processing of the respective paper is blocked.

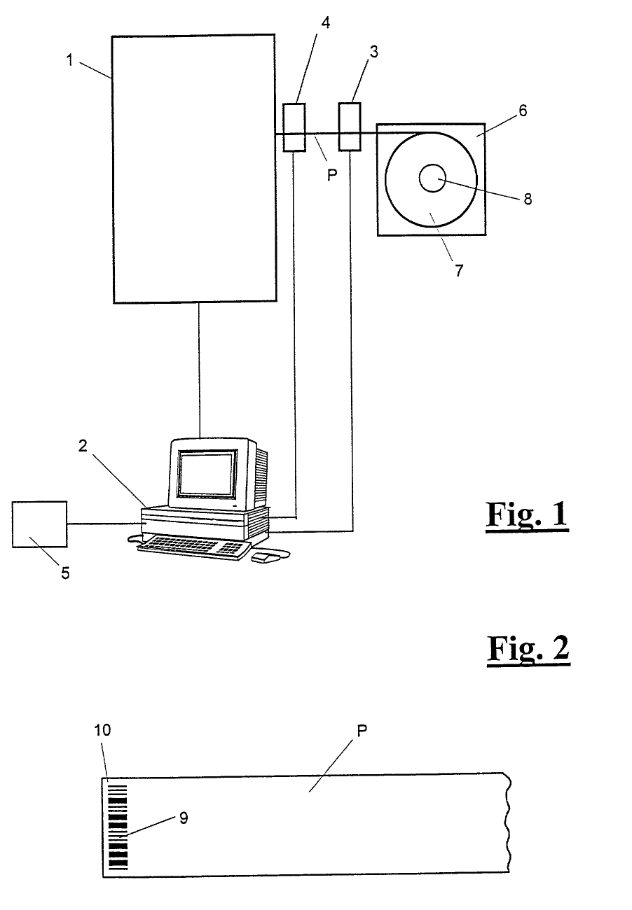

In the embodiment of FIGS. 1 and 2, the identification code is in the form of a barcode 9 printed onto the beginning 10 of the paper P, as illustrated in FIG. 2. When a paper cassette 6 is coupled to the processing unit 1, the identification code is read off by the reader arrangement 3 and fed to the control unit 2. The latter supplies the identification code to the administration arrangement 5. Of course the administration arrangement 5 can also be a component of the control unit 2. It is preferably constructed in such a way that it cannot be manipulated by the operator of the processing device.

All permissible identification codes are preferably stored in the administration arrangement 5. The administration arrangement checks the actual identification codes read off the paper P for correspondence with one of the stored permissible identification codes and transmits the test result to the control unit 2 in a suitable format. Depending on the result of the check, the control unit 2 then accepts the paper P used or blocks the processing thereof, whereby, of course, a suitable message is produced.

When the processing of the paper P is completed and paper is still left in the roll 7, the identification code is again printed in machine readable format onto (the now new) beginning 10 of the paper P by way of recording arrangement 4.

It is understood that the control unit 2 is constructed for communication with the barcode reader 3, the barcode printer 4 and the administration arrangement 5. However, the person skilled in the art does not need any further explanation in this respect.

It is further important for a perfect and error-free functioning of a mini-lab (or comparable print producing arrangements) that the control unit knows the property data of the respectively used paper which are relevant for the processing. These property data include especially the paper type, by way of which the correct paper profile is adjusted, the paper width which determines the possible print formats, and the available (remaining) paper length, which determines the order volume processable with the remaining paper. These property data were so far manually entered and then accordingly used by the control unit.

In a further preferred embodiment of the invention, those property data are no longer entered manually but are recorded on the paper web, read off from there and provided to the control unit at the beginning of the processing so that the control unit can make the required adjustments (in a way generally known) by way of the read off data. The property data are, as shown in FIG. 2, also printed onto the beginning (leading end) 10 of the paper web P in the form of a barcode 9. For a new paper roll 7, this can be done at the manufacturer or also before the first use of the paper roll by the user. The reading of this barcode 9 is again carried out in a known manner by way of a (generally conventional) barcode reader 3.

When the paper roll 7 is removed and not yet empty, the (actual) property data of the paper web P are again applied to the beginning of the remaining paper, in accordance with a further important aspect of the invention, so that the data are again available for the next use. The application of the barcode for the identification code is carried out in a manner known by way of a (generally conventional) barcode printer 4.

After completion of a print order, the actual remaining paper length in the roll 7 is of course less than the original nominal length. Of course, not the original length is now recorded but only the leftover remaining length (original length minus actual paper usage). In this manner, the control unit 2 is always informed of-the available remaining paper amount after docking of a paper roll 7.

The printing on the (updated) property data can also be carried out after each print order, even when the paper roll P is not removed. Of course, the code can also be, for example, printed onto an adhesive label and the latter applied onto the paper web.

By application of the barcode, (or another machine readable code) onto the beginning of the paper roll, the latter is in a way “sealed”. When then the barcode is missing it can be assumed that paper has already been removed. In that case, the property data (as before) must be manually entered into the control unit.

According to a further aspect of the invention, the security against manipulation attempts can be increased in that the identification code of the paper is linked with the (remaining) length of the paper on the paper roll 7. The initial or remaining length of paper to be processed is stored therefor in the administration arrangement 5 in association with the respective identification codes. When a paper roll 7 is used, the read-in remaining length of which does not correspond with the remaining length stored previously during the last processing, especially when the read-in remaining length is larger than the stored remaining length, the processing of the respective paper roll 7 is blocked.

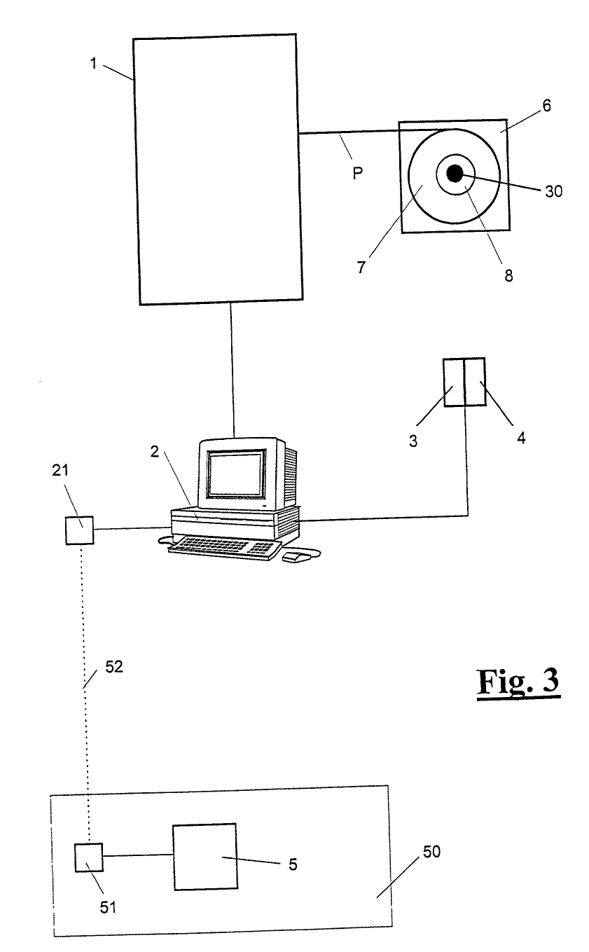

FIG. 3 shows a second preferred embodiment of the processing device in accordance with the invention. This variant is intended for paper P or in general webs of material, wherein the identification code and the property data of the paper are not placed on the paper itself but according to a further preferred aspect of the invention in machine readable format on the core 8 of the paper roll 7. The identification code and the property data are thereby applied onto or connected to the core 8 in such a way that it cannot be removed without destruction.

A passive storage element without inherent power supply is especially suited as carrier for the identification code and the property data, which element is accessed by electromagnetic waves. Such a storage element consists essentially of an integrated circuit with emitter/receiver functions and a data storage and in general a coil type antenna through which on the one hand the required operating energy is provided and on the other hand data are received and emitted. Suitable passive storage elements and the associated apparatus (transponder) for communication with the storage elements are generally known and sold by the company Texas Instruments, Dallas, Texas, USA, under the trade name TAG-IT™. In the embodiment of FIG. 3, such a passive element 30 is fastened to the core 8 of all permissible paper rolls 7 and includes in its data storage the identification code and the property data of the paper P.

The reader arrangement 3 and the recording arrangement 4 are together constructed as a transceiver (“transponder”) adapted for the communication with the passive storage element and can over a (limited) distance read data from the storage element 30 and transmit data to the storage element for storage therein. The transceiver 3-4 is of course controlled by the control unit 2 in a manner known in the art.

The analysis of the data (identification code and property data of the paper P) read off the paper roll 7 by way of the transceiver 3-4 is carried out in the same manner as in the embodiment of FIGS. 1 and 2.

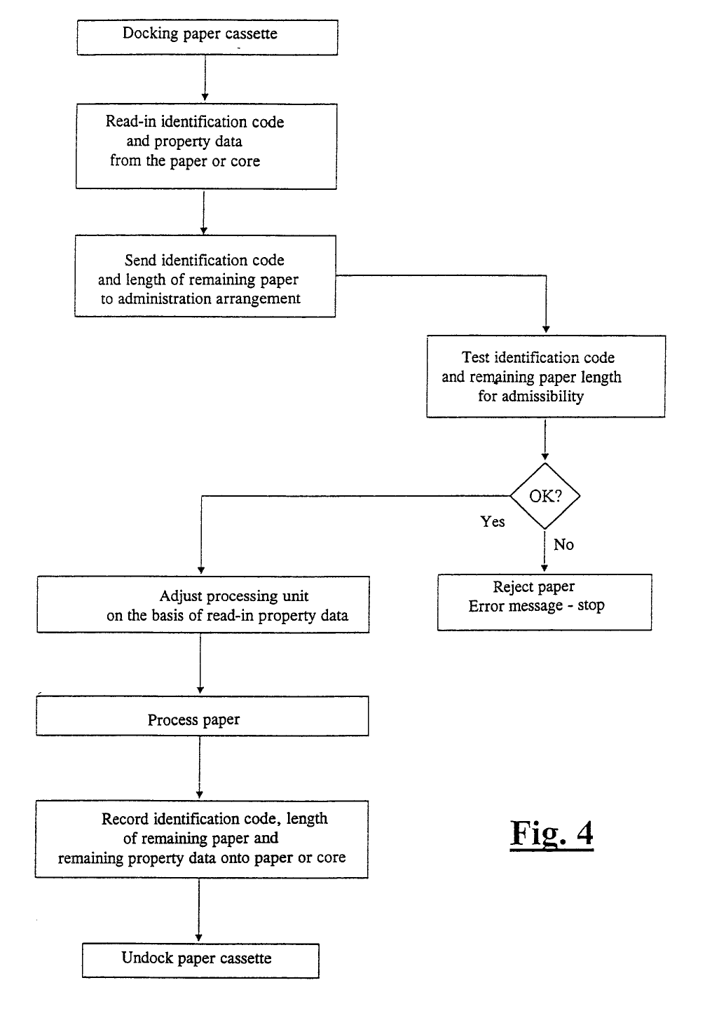

FIG. 4 shows in schematic overview the essential steps of the processing method in accordance with the invention. The individual blocks of the processing diagram are self-explanatory and, therefore do not require any further explanation.

The method in accordance with the invention is especially suited for central administration. The administration arrangement 5 hereby is located, as illustrated in FIG. 3, in an administration center 50 remote from the processing apparatus 1-2 and is connected or connectable with the control unit 2 through a telecommunications channel 52. The communication can take place, for example, through a modem 51 or 21.

The administration center is located, for example, at the manufacturer of the processing apparatus and allows the manufacturer to supervise the use of permitted paper types. Of course, the central administration arrangement 5 can thereby be connected with or co-operate with several processing apparatus 1-2.

According to a further aspect of the invention, the administration arrangement 5 can be constructed such that for each processing apparatus connected thereto, identification codes can be selectively activated (released) depending on certain conditions. Such a condition can consist, for example, in that the operator of the processing apparatus has acquired a paper roll with the corresponding identification code.

Furthermore, the administration arrangement 5 can also be constructed such that it recognizes when a paper roll 7 with a valid identification code is used for the first time. The central administration arrangement 5 can then initiate or carry out a passive action program, for example, an invoicing.

The method in accordance with the invention is very user friendly and substantially prevents the use of non-authorized paper types as well as false manipulations. The marking in accordance with the invention with a machinery identification code, especially with the use of storage elements activatable by electromagnetic waves, can also be expanded to other consumable materials for the processing device. In the case of mini-labs or comparable picture manufacturing devices, especially containers for printer inks, for example, can be provided with identification codes so that the use of unauthorized printer inks can be prevented.

1. A method for processing a web of material stored in the form of a roll in a processing device, comprising the steps of connecting an identification code in machine readable form with the web of material or with a core onto which the web material is wound, reading off the identification code at the beginning of the processing, analysing the code by way of an administration arrangement that cannot be manipulated by the user, and blocking processing of the web material in the processing device by the administration arrangement when the latter was unable to detect a valid identification code.

2. Method according to claim 1, including the further steps of connecting property data of properties of the web material relevant for the processing in machine readable form with the web material or the core, reading off and analyzing the property data, adjusting the processing device by way of property data machine read at the beginning of the processing, and connecting at least those property data of the web material which have changed during processing with the remaining web material or the core, at least after a partial-processing of the web material, and again in machine readable form.

3. Method according to claim 2, wherein the property data connected with the web material or the core include the initial or remaining length of the web material stored on the roll and the remaining length of the web material left over after processing of the web material is part of the data connected in machine readable form with the web material or the core.

4. Method according to claim 3, including the further steps of storing the remaining length of the web material left over in the roll after the partial processing of the web material in the administration arrangement in association with the identification code of the web material, testing before commencement of each processing of the web material whether the remaining length of web material machine read from the web material or the core corresponds with the remaining length stored in the administration arrangement and, in the case of non-correspondence, blocking the processing of the web material.

5. Method according to claim 2, wherein the property data connected with the web material or the core include the width of the web material.

6. Method according to claim 2, wherein the property data connected with the web material or the core include the type of the web material.

7. Method according to claim 2, wherein the identification code and, possibly, the property data of the web material are applied to the beginning of the web material in the form of a machine readable code and whereby the identification code and possibly the property data of the web material which have changed during processing are again applied in the form of a machine-readable code onto the new beginning of the web material remaining after a partial processing thereof.

8. Method according to claim 7, wherein the identification code and the property data are applied onto the web material in the form of a barcode.

9. Method according to claim 2, wherein the identification code and possibly the property data are stored in a storage element activatable and accessible by way of electromagnetic fields, which storage element is connected with the core of the web material in such a way that it cannot be removed without destruction.

10. Method according to claim 1, wherein the administration arrangement is provided in or in fixed association to the processing device.

11. Method according to claim 1, including the steps of providing data communication between the administration arrangement which is positioned in an administration center and a remote processing device through a telecommunications channel.

12. Method according to claim 1, including the further steps of selectively activating or deactivating the identification code by way of the administration arrangement, and accepting only web materials with activated identification code for processing in the processing device.

13. Method according to claim 1, including the further steps of determining by way of the administration arrangement and the identification code whether a web material is processed for the first time in the processing device, and initiating a predetermined action program.

14. Apparatus for the processing of a web of material stored in the form of a roll wound onto a core and having a machine readable identification code thereon, comprising a web processing device, a processor based control unit for the latter, a machine reader arrangement for reading the machine readable identification code off the web of material or the core; and an administration arrangement for co-operating with the reader arrangement and the control unit and being constructed to be not manipulatable by the user, the administration arrangement receiving and analysing the identification code read by the reader arrangement and blocking the processing of the web material by way of the control unit when a valid identification code cannot be identified.

15. Apparatus according to claim 14, wherein the reader arrangement is adapted to read and provide to the control unit additional property data connected with the web material or the core in machine readable form and of properties relevant for the processing of the web material, whereby the control unit is constructed for adjusting the processing unit to the properties of the web material on the basis of the property data supplied to the control unit, and the apparatus further including a recording arrangement for co-operating with the control unit and, at least after a partial processing of the web material, again connecting at least those property data of the material web which possibly have changed during the processing in machine readable form with the remaining web material or the core.

16. Apparatus, according to claim 15, wherein the original or remaining length of the web material stored in the roll is part of the property data connected with the web material or the core, and wherein the reader arrangement is constructed to read the original or remaining length, the control unit is constructed for determining the remaining length of the web material left over after the processing of the web material, and the recording arrangement being constructed for again connecting in machine readable form the remaining length of the web material with the web material or the core.

17. Apparatus according to claim 16, wherein the administration arrangement stores the remaining length of the web material remaining after the partial processing on the web material in association with the identification code and the administration arrangement tests before,the start of each processing whether the remaining length of the web material machine read off the web material or the core corresponds with the remaining length stored in the administration arrangement, whereby the administration arrangement blocks the processing of the web material through the control unit in the case of non-correspondence.

18. Apparatus according to claim 14, wherein the reader arrangement is a barcode reader and the recording arrangement is a barcode printer and the control unit and the recording arrangement are adapted for printing onto the web material the identification code and the remaining length of the material web leftover in the roll after the partial processing of the web material.

19. Apparatus according to claim 14, wherein at least one of the identification code and the property data are stored in a storage element activatable and accessible by electromagnetic fields, which element is connected with and cannot be removed from the core of the web material without destruction and that the reader arrangement and the recording arrangement are constructed as a transceiver for control of the storage element.

20. Apparatus according to claim 14, wherein the administration arrangement is positioned in the processing unit.

21. Apparatus according to claim 14, wherein the administration arrangement is constructed as a part of the control unit.

22. Apparatus according to claims 14, wherein the administration arrangement is remote from the processing device and connected therewith through a telecommunications channel.

23. Apparatus according to claim 20, wherein the administration arrangement is adapted to selectively activate or deactivate identification codes and to only allow web materials with activated identification codes for processing in the processing device.

24. Apparatus according to claim 20, wherein the administration arrangement is adapted to determine by way of the identification codes when a web material is processed for the first time in the processing device and to thereby activate and carry out a preselected action program.
